(19) United States
(12) Patent Application Publication
(10) Pub. No.: US 2017/0284136 A1
(43) Pub. Date: Oct. 5, 2017

(54) Gate Hinge and Latch With Direct Attachment to a Support Post and One-Handed Opening of Latch and Gate

(71) Applicant: Rex A. Ramsey, Forney, TX (US)

(72) Inventor: Rex A. Ramsey, Forney, TX (US)

(21) Appl. No.: 15/624,966

(22) Filed: Jun. 16, 2017

Related U.S. Application Data
(63) Continuation-in-part of application No. 15/298,450, filed on Oct. 20, 2016.
(60) Provisional application No. 62/300,963, filed on Feb. 29, 2016.

(51) Int. Cl. E05C 3/14; E06B 11/02; E05D 3/02; E05D 5/02; E04H 17/14; E05C 3/00

(52) U.S. Cl. CPC E05C 3/14; E04H 17/14; E05C 3/006; E05D 3/02; E05D 5/02; E06B 11/022; E05Y 2900/40

(57) ABSTRACT

A fence system with a gate assembly mounted in a gap between first and second fence portions of the fence system. A hinge may be used to mount the gate assembly, where the hinge has a clamp fixed to a support with substantially the same cross-section, and the support is fixed to a first member of the hinge. A second member of the hinge can be mounted to the gate assembly with the first and second members being rotatably fixed together, thereby allowing rotation of the gate assembly between open, closed, and various other positions. A latch actuator can selectively secure and release a latch retainer thereby selectively allowing the gate to rotate to the various positions. A handle can be positioned proximate the latch actuator to allow gripping of the handle and manipulating the actuator with one hand, thereby releasing the retainer.

### CROSS-REFERENCE TO RELATED APPLICATIONS

This application is a continuation-in-part of U.S. patent application Ser. No. 15/298,450, filed 20 Oct. 2016, which claims the benefit under 35 USC §119 of the filing date of U.S. Provisional Patent Application Ser. No. 62/300,963 filed 29 Feb. 2016. The entire disclosures of these prior applications are incorporated herein by this reference.

### BACKGROUND

Fence systems are generally used to separate areas of land from other areas, and control ingress and egress between the separated areas, such as a fence around ranch land to keep livestock within the borders of the fence or keep livestock and others outside of the fence borders. These systems can also include backyard fences, business fences, playground fences, school yard fences, etc. Some of these are wood fences, which have wood pickets and support rails, with a metal support system. The metal support system can include posts that are secured in the ground and brackets used to attach the wooden fence material to the post. These systems normally have hinged gates that control traffic and access through points of entry in the fence system. These gates can be mounted to the support system by hinges to allow rotation of the gate to control access, and a latch system can be used to latch the gate in a closed position. These hinges and latch systems have generally been mounted to wooden pickets and/or support rails that over time cause degradation of the attachment due to aging of the wooden material.

Additionally, current latch systems normally require both hands to disengage the latch and release the gate. One hand is generally used to grab a handle while the other hand is needed to disengage the latch, thereby freeing the gate to be opened by a force applied to the handle. This can cause problems, such as when someone is carrying groceries or other items and must use two separate parts of the body (two hands, a hand and a knee, a hand and an elbow, etc.) to release the latch and pull on the handle.

Therefore, it will be readily appreciated that improvements in the arts of fence systems are continually needed.

### SUMMARY

The present disclosure relates generally to fence systems, and, in an embodiment described herein, more particularly provides a hinge and a latch for a gate that attaches directly to a support post. The gate latch can allow a user to disengage the latch and open the gate one-handed.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. Embodiments are described in detail hereinafter with reference to the accompanying figures, in which:

FIG. 1A is a representative front view of a fence system including a gate that is installed using a hinge and a latch set that can embody principles of the current disclosure.

FIG. 1B is a representative front view of a fence system including a gate that is installed using a hinge and a one-handed latch set that can embody principles of the current disclosure.

FIG. 2 is a representative rear view of the fence system of FIG. 1.

FIG. 3A is a representative top view of a gate installation in the fence system of FIGS. 1A or 1B.

FIGS. 3B-3E are representative top views of gate installations with various one-handed latch systems that can embody principles of the present disclosure.

FIGS. 4A-4B are representative perspective views of two embodiments of a hinge which can embody principles of the present disclosure.

FIGS. 5A, 5B, 5C are a representative top view, a representative cross-sectional, and a representative rear view, respectively, of the hinge of FIG. 4A.

FIGS. 6A, 6B are a representative top view, and a representative rear view of the hinge of FIG. 4B.

FIGS. 7A-7B are representative perspective views of the hinge of FIG. 4A which are partially pivoted about an axis.

FIGS. 8A-8B are representative perspective views of a latch actuator for a latch that can embody principles of the present disclosure.

FIGS. 9A-9B are representative perspective views of another embodiment of a hinge which can embody principles of the present disclosure.

### DETAILED DESCRIPTION OF THE DISCLOSURE

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

As used herein, the words “comprise,” “have,” “include,” and all grammatical variations thereof are each intended to have an open, non-limiting meaning that does not exclude additional elements or steps. While compositions and methods are described in terms of “comprising,” “containing,” or “including” various components or steps, the compositions and methods also can “consist essentially of” or “consist of” the various components and steps. It should also be understood that, as used herein, “first,” “second,” and “third,” are assigned arbitrarily and are merely intended to differentiate between two or more objects, etc., as the case may be, and does not indicate any sequence. Furthermore, it is to be understood that the mere use of the word “first” does not require that there be any “second,” and the mere use of the word “second” does not require that there be any “first” or “third,” etc.

The terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

Generally, this disclosure provides a fence system as well as a method to assembly and operate the fence system, where the fence system can include first and second fence portions, a gate assembly positioned between the first and second fence portions, at least one hinge that rotatably mounts the gate assembly to a first post of the first fence portion, and a latch system that can include a latch actuator, a latch retainer, and a handle, where the latch retainer engages the latch actuator and latches the gate in a closed position, and the handle is configured to allow a user to grip the handle and manipulate the actuator with one hand, which disengages the latch retainer from the latch actuator.

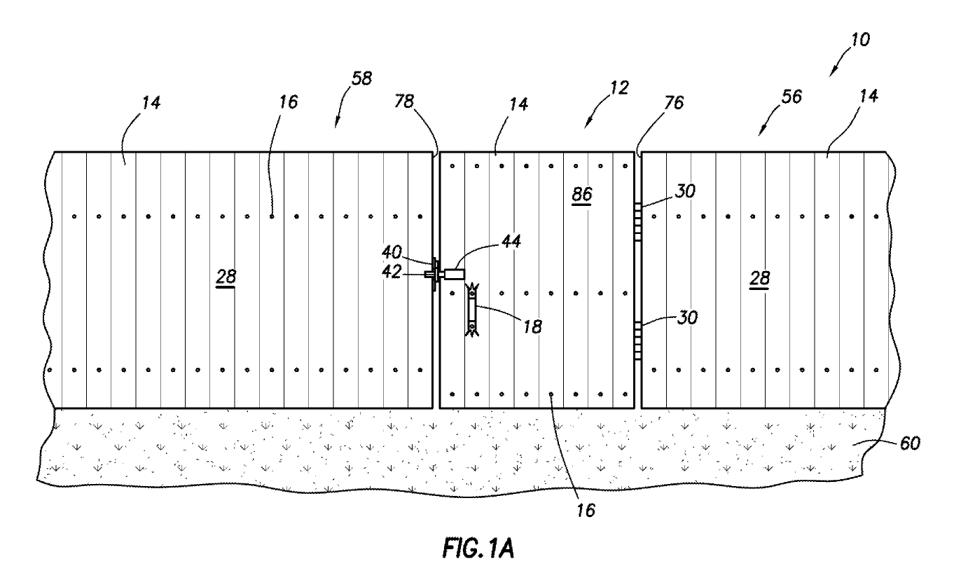

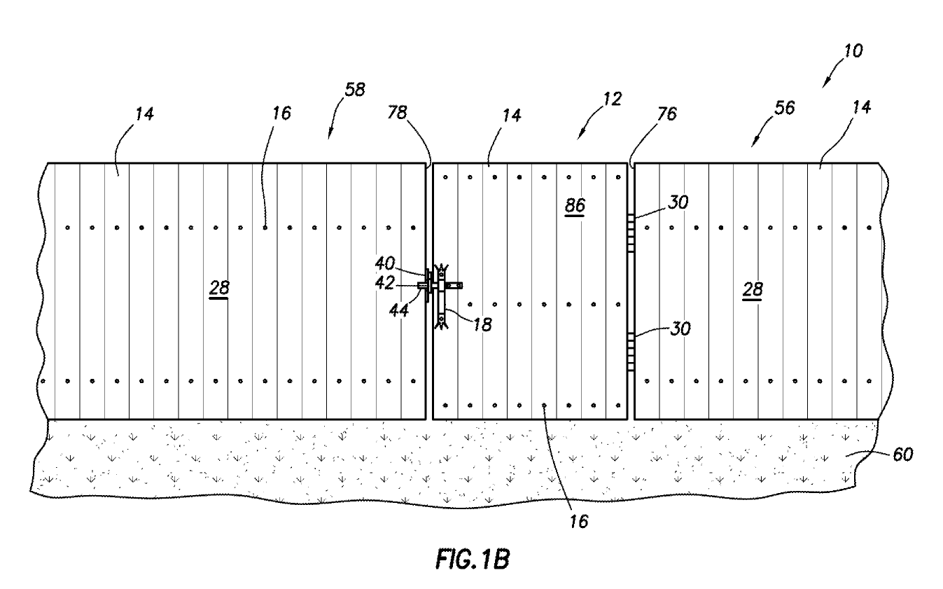

Representatively illustrated in FIG. 1A is a front view of a fence system 10 with a hinge 30 and latch 40 for a gate assembly 12 that can embody principles of this disclosure. The fence system 10 shown in FIG. 1A is a type of fence system 10 that may be referred to as a privacy fence. FIG. 1A shows a fence system 10 with wooden pickets 14 that provide a barrier between two areas, with one area in front of the fence system 10 and the other area in back of the fence system 10. Someone in the front area may view a more esthetic side of the fence system 10, without being able to see some of the supporting structures (e.g. posts, brackets, fence back rails, gate support frame, etc.) on a back side of the fence system 10. A wall of pickets 14 may provide a uniform appearance when viewed from the front area. FIG. 1A shows pickets 14 positioned side-by-side along the fence system 10 with minimal to no gap between adjacent pickets 14.

However, it is not required that the fence system 10 be a wooden fence system, a privacy fence system, or a wooden privacy fence system. For example, the fence system 10 can be a decorative fence that allows at least partial viewing through the pickets 14. Additionally, the fence system 10 can be short enough for people in the front area to see over the fence system 10 into the back area. The fence material for the pickets, posts, support rails, etc. can be wooden, and various other materials can also be used, such as metal (aluminum, steel, galvanized metal, iron, alloys, etc.), plastic, composites, etc.

Many fence systems have hinges that are mounted to pickets and/or support rails of the fence system. These hinges may have a tendency to degrade the attachment of the hinges to the pickets and/or support rails. This degradation may lead to loose hinges and thus allowing the hinges to move relative to the pickets and/or support rails. The more movement is allowed at the hinge attachment points the more operation problems can be caused for the gate, such as misalignment, failure of the latch, gate dragging on ground when opening or closing, etc.

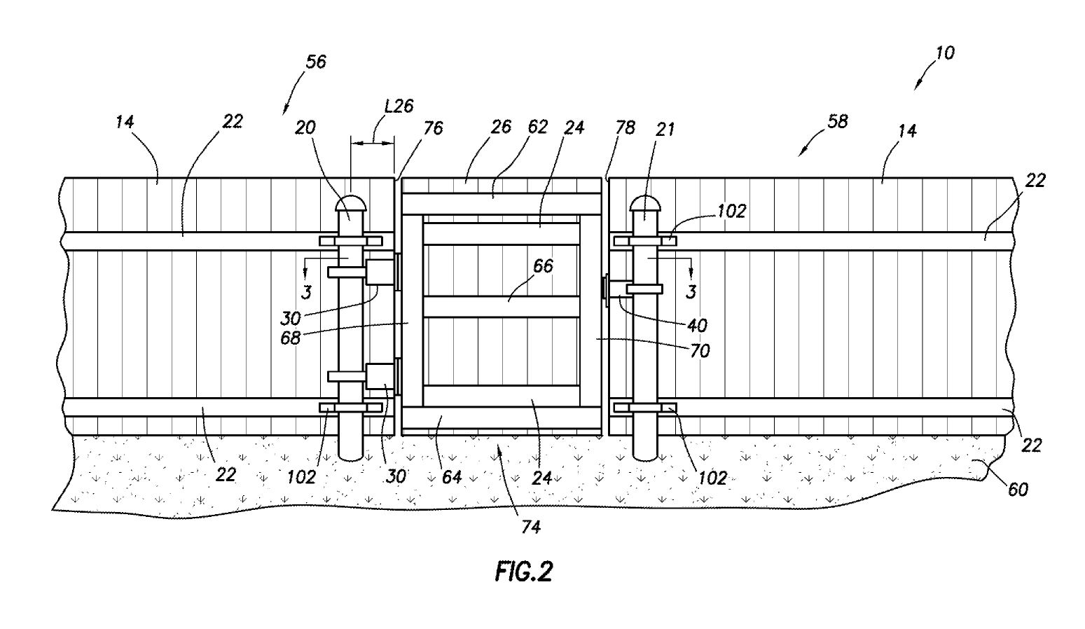

The fence system 10 has multiple pickets 14 mounted to backer rails 22 (not shown, see FIG. 2) to form a wall of pickets 14 that can be a barrier between the front and back areas. A gate assembly 12 is installed in a gap between left and right portions 56, 58 of the fence system 10 (please note that the left and right portions 56, 58 are in reference to the rear view in FIG. 2). The gate assembly may help control access between the front and back areas. One or more hinges 30 may be attached between the gate assembly 12, thereby pivotally mounting the gate assembly 12 to the left portion 56. A latch 40 can be mounted between the gate assembly 12 and the right portion 58. The latch 40 can include an actuator 42 and a retainer 44, with the actuator 42 mounted to one of the gate assembly 12 or the right portion 58, and the retainer 44 mounted to the other. Therefore, when the gate assembly 12 is rotated about an axis 32 of the hinges 30, the retainer 44 can engage the actuator 42, latching the retainer 44 in the actuator 42, and preventing disengagement of the retainer 44 from the actuator 42, thereby preventing rotation of the gate assembly 12. If the actuator 42 is again actuated, the retainer 44 can be released from the actuator 42, thereby allowing the gate to be rotated to an open position.

FIG. 1A shows a ground 60 to which the fence system 10 can be assembled. The ground 60 is shown to be dirt with grass on its surface, but the ground 60 can also refer to concrete, rocks, gravel, or any suitable surface for installing the fence system 10. FIG. 1 also shows fasteners 16 that may be used to attach the pickets 14 to backer rails 22 (see FIG. 2). The fasteners 16 can be any fastener that is suitable for attaching the pickets 14 to a support structure of the fence, such as backer rails 22.

FIG. 1B shows a fence system 10 that is similar to the fence system in FIG. 1A, except that this fence system has a gate latch that can be operated with only one hand. The handle 18 is positioned in close proximity to the latch actuator 42 so that a user can release the latch retainer 44 while pulling on the handle 18 at the same time and with the same hand. For example, the user can release the latch retainer 44 with a thumb on the right hand while pulling on the handle with one or more fingers of the right hand. It should be understood that either hand can be used to operate the latch system, as well as both hands (if so desired) and/or mechanical hands or devices. However, it is noteworthy that the gate can be opened by using fewer resources (e.g. one hand instead of two, fewer mechanical devices, one mechanical prosthetic instead of two, etc.). This can allow a user to keep control of a dog's lease in one hand and open the gate with the other hand, thereby, maintaining better control of the dog during access through the gate. As used herein, the term “hand” or “one-handed” refers to an appendage of a user, which includes a user's hand, a robotic hand, a mechanical prosthetic, and any other devices that assist the user in gripping and/or picking up objects.

Representatively illustrated in FIG. 2 is a rear view of the fence system 10. The gate assembly 12 is installed in a gap between the left portion 56 and the right portion 58 of the fence system 10. The left portion 56 and right portion 58 can include pickets 14 attached in a vertical orientation to the backer rails 22 with fasteners 16. The backer rails 22 can be attached in a horizontal orientation to support posts 20 with brackets 102. However, it is not required that the pickets 14 and the backer rails 22 be oriented as shown in FIG. 2. The backer rails 22 and pickets 14 could be attached in the fence system 10 in various orientations, for example to match a contour of the ground 60, to provide angled pickets 14 for a different esthetic, etc.

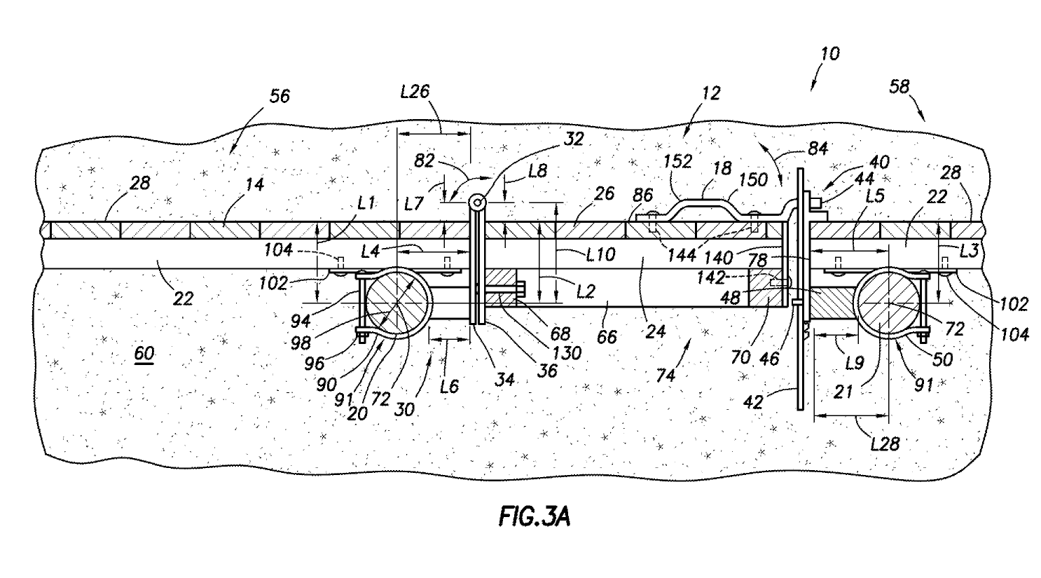

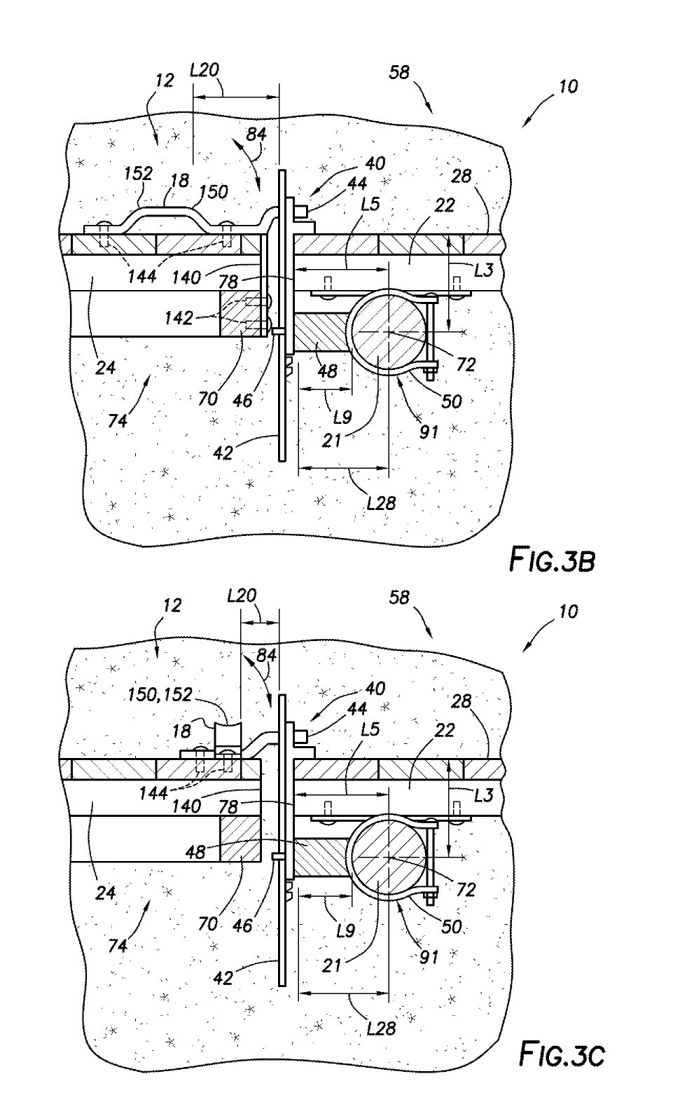

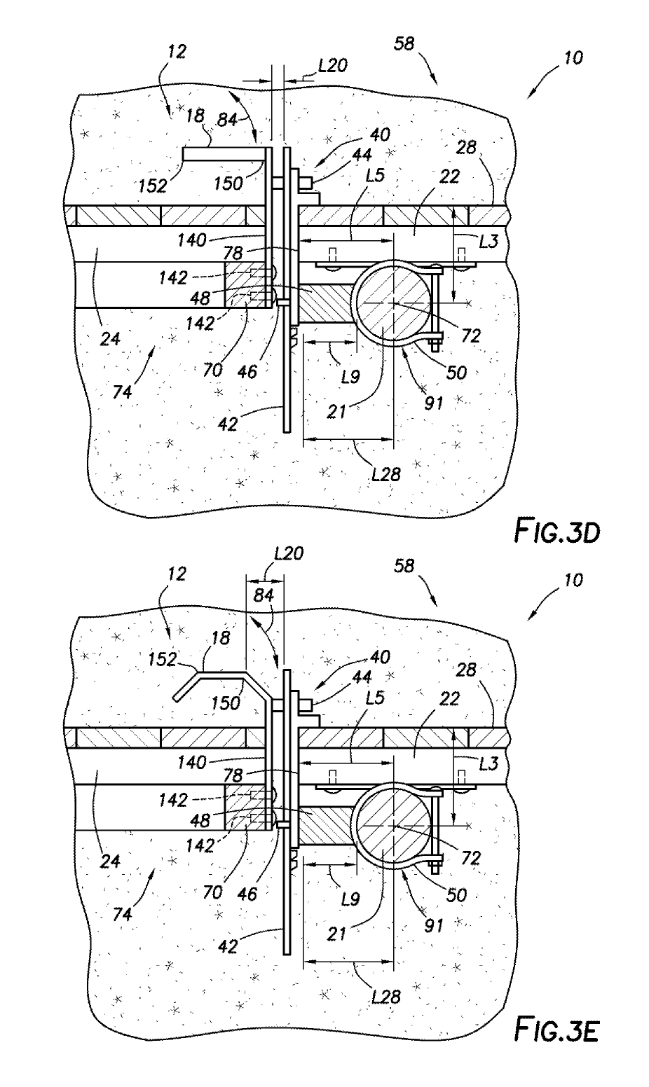

As seen in FIG. 2, a bracket 102 extends to a left and right of a post 20, 21. The bracket 102 can include a clamp portion that clamps the bracket 102 to the post 20, 21, and a flange portion that attaches to a backer rail 22, thereby securing the backer rails 22 to the bracket 102 and thus to the post 20, 21. The flange extends to the left and right of the post 20, 21 along the backer rail 22, and can provide clearance beside the post 20, 21 to install fasteners through holes in the bracket 102 and into the backer rail 22. The flange extension, causes the backer rails 22 and the pickets 14 of the left and right fence portions 56, 58 to be extended past the posts 20, 21, respectively. This extension causes the posts 20, 21 to be inset back from the edges 76, 78, respectively. This creates a length L26 between an edge 76 and a center 72 of the post 20, and length L28 (see FIG. 3A) between an edge 78 and a center 72 of the post 21.

FIG. 2 shows a support structure of the gate assembly 12 that can be used to provide strength and stability to the gate assembly and provide support for attaching backer rails 24 and pickets 26 in the gate assembly. The structure can include left and right vertical supports 68, 70, and top, middle, and bottom supports 62, 66, 64 that are fixedly attached together (such as with welding, fasteners, etc.) to form a generally rectangular-shaped frame 74. However, please note that this frame 74 can be made to any number of shapes, such as circular, square, oval, triangular, etc. and any number of supports can be used to create these different shaped frames 74. For example, the frame 74 in FIG. 2 can be made with two supports 66 in the middle with the supports 66 crisscrossing each other to form an “X” shape. Therefore, it is clearly understood that various shapes and sizes of frames 74, and various arrangements and sizes of supports can be used in keeping with principles of the current disclosure. Please note that the supports 62, 66, 64, 68, and 70 can be made of any material suitable for maintaining structural integrity of the gate assembly (such as metal, wood, plastic, etc.).

Two hinges 30 are fixedly attached to the post 20 and the support 68 of the frame 74, with the pivot 33 (such as a pin, etc.) positioned between the support 68 and the post 20. This allows the gate assembly to pivot about the axis 32 of the pivot 33 to open, closed, or somewhere in between the open and closed positions. It is generally desired to latch the gate assembly 12 in the closed position when it is pivoted to the closed position. The latch 40 can provide this latching function for the fence system 10. The actuator 42 of the latch 40 can be fixedly attached to the post 21 (such as with clamps, welding, fasteners, etc.). The latch retainer 44 can be fixedly attached the gate assembly 12 in a position that allows engagement of the actuator 42 when the gate assembly 12 is pivoted to its closed position. The retainer 44 could be mounted to a front surface 86 of the gate assembly 12 and extend from the surface 86 to engagement with the actuator 42. Alternatively, or in addition to, the retainer could be mounted to the support 70 and extend to the front surface 86. Various arrangements and attachments can be used for the retainer 44, as long as the retainer 44 engages the actuator 42 and latches the gate assembly 12 in its closed position. To release the retainer 44, the actuator 42 can merely be actuated again to allow the retainer 44 to be moved out of engagement with the actuator 42.

Referring to FIG. 3A, this is generally a cross-sectional view taken along line 3-3 in FIG. 2. Details of the hinge 30 and latch 40 are more clearly seen. The fence system 10 includes the pickets 14 of the fence portions 56, 58 mounted to backer rails 22, and the pickets 26 of the gate assembly 12 mounted to the backer rails 24. The brackets 102 can be mounted to the backer rails 22 with fasteners 104. The brackets 102 can be mounted to the posts 20, 21 with clamp portions (not shown), thereby fixedly attaching the pickets 14, to the backer rails 22, and thus to the posts 20, 21. This can result in a distance L1 between the center 72 of post 20 and the surface 28, and a distance L3 between the center 72 of post 21 and the surface 28. Distances L1, L3 are substantially equal in FIG. 3A, but can be different values if desired. The main desire may be that the surface 28 of the left portion 56 is generally in the same plane as the surface 28 of the right portion 58, however, this is not a requirement of the fence system 10. The distance L2 is a distance between the center 72 of post 20 and the surface 86 of the gate assembly 12 when the gate assembly 12 is in a closed position. As used herein, “the same plane” refers to a plane that is formed by the surfaces 28 of the left and right fence portions 56, 58 that are proximate the gate assembly, and that these surfaces 28 are aligned with the surface 86 of the gate assembly 12, such that the surface 86 lies generally within the plane. As used herein, “generally in the same plane” can include various undulations of the surfaces 28, 86, and various small protrusions from the plane caused by physical properties of the pickets 14 and/or fence system 10. However, on average the surface 28 proximate the gate assembly and the surface 86 are aligned with each other when the gate assembly is in a closed position.

Possibly due to the brackets 102 (but could be due to other factors as well), the posts 20, 21 are inset from the edges 76, 78, at distances L26, L28, respectively. Various prior art hinges are mounted to the surface 28 of the pickets 14 with fasteners that may extend through a hinge flange, through a picket 14 and into a backer rail 22. These hinges are prone to the fasteners degrading their attachment to the pickets 14 and backer rails 22 such that they can allow the gate assembly to sage (or otherwise become misaligned) causing interference of the gate with the right portion 58, the ground 60, the actuator 42, etc. The prior art hinge may continue to wobble relative to its fasteners causing further degradation and possibly failure of the attachment. Even if the fasteners of the prior art hinges were extended into the post 20, there may still be a tendency to degrade the stability of the attachment due to the pickets 14 and backer rails 22 being made from more pliable material (e.g. wood, composite, plastic, thin metal, corrugated metal, etc.). This pliability can allow the attachment of the prior hinges to degrade over time to an extent that it can prevent the gate assembly 12 from working properly.

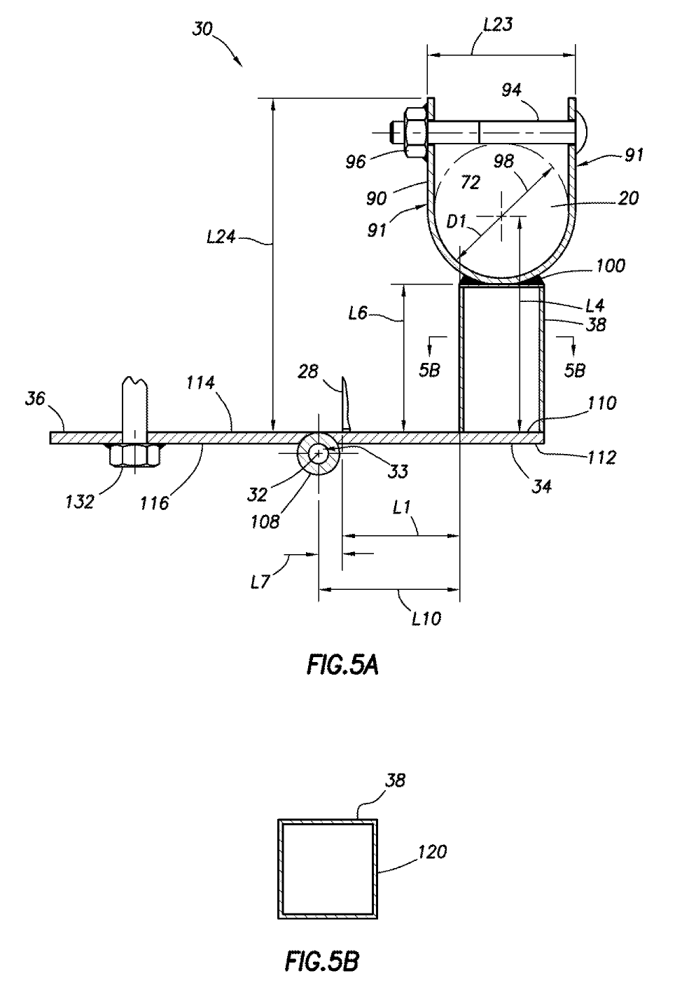

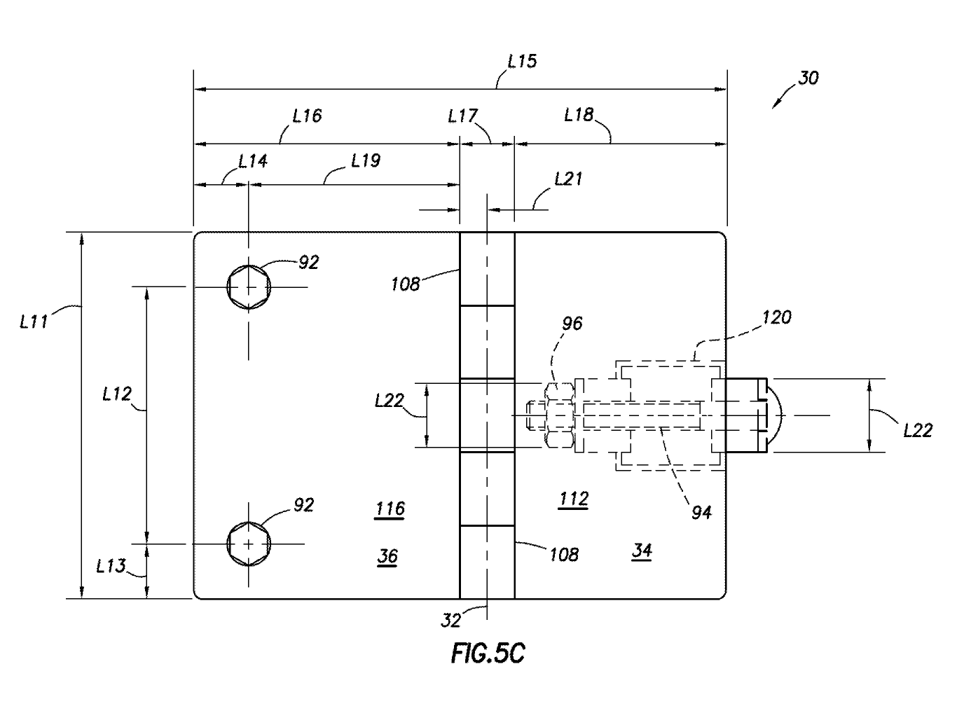

The hinge 30 and latch 40 of the current disclosure can be used to eliminate (or at least minimize) degradation of its attachment to the posts 20, 21, respectively. The hinge 30 and latch 40 can be attached directly to either one of the posts 20, 21 via a rigid (reduced pliability) material (such as steel, aluminum, hardened plastic, composites, etc.) without fastening to and/or through other fence material(s) (such as pickets 14, backer rails 22, etc.). This means that the other fence material(s) are not used in the attachment of the hinge 30 or latch 40 to either one of the posts 20, 21. The other fence material(s) may be attached to the posts 20, 21, but they are more accurately seen as being attached in “parallel” to, but not incorporated into, the attachment of the hinge 30 or the latch 40 to either one of the posts 20, 21. The term “parallel” refers to separate connections of the hinge 30 (or latch 40) and the other material(s) to either one of the posts 20, 21. The hinge 30 can include left and right members 34, 36, with the right member 36 being fastened directly to the support 68 of the gate assembly 12. This support can also be made from a rigid (reduced pliability) material (such as steel, aluminum, hardened plastic, etc.). The right member 36 can include a captive nut 132 (see FIG. 5A) for ease of assembly, but it is not required for the nut 132 to be captive. The nut 132 can receive the fastener 130 to secure the gate assembly's frame support 68 to the hinge's right member 36.

The left member 34 can have a support member 38 fixedly attached between it and a clamp 90. The support member 38 can have a length L6, where the length L6 is determined by the length of the support member 38 that is needed to position the left member 34 generally perpendicular to the surface 28 of the left portion 56 and adjacent the edge 76. The clamp 90 can be used to surround the post 20 and fixedly attach the left member 34 of the hinge 30 to the post 20. The post 20 can be a wooden or metal post, and can have different cross-sections than the circular cross-section shown in FIG. 3A. For example, the post can be rectangular-shaped, such as 4×4, 4×6, 6×6, etc. treated lumber, somewhat oval-shaped with wooden or metal posts, etc.

The clamp 90 can at least partially surround the post 20 which can have a diameter 98. The arms of the clamp 90 that extend around opposite sides of the post 20 can be secured together by a fastener 94 and nut 96. By installing the nut 96 onto the fastener 94, the clamp arms are pulled together thereby squeezing the post between the arms and securing the left member 34 to the post 20. The fastener 94 can be any suitable fastener such as a bolt, a U-shaped bolt, a screw, etc.

The left and right members 34, 36 are pivotally attached at an axis 32, which allows the gate assembly 12 to pivot (as indicated by arrows 82) about the axis 32. The axis 32 can be a distance L7 in front of the surface 28 of the left portion 56, and the axis 32 can be a distance L8 in front of the surface 86 to accommodate various hinge 30 arrangements. It is preferred that the distances L7, L8 be a same value, but it is not required for these distances L7, L8 to be the same value. The distances L7, L8 can also be a value of “zero” if it is desired that the axis 32 aligns with the surfaces 28, 86.

The latch 40 can include the actuator 42 and the retainer 44. The actuator 42 can have a support member 48 fixedly attached between it and a clamp 50 (which can be similar to clamp 90). The support member 48 can have a length L9, where the length L9 is determined by the length of the support member 48 that is needed to position the actuator 42 generally perpendicular to the surface 28 of the right portion 58 and adjacent the edge 78. Please note that the support members 38, 48 can be made from a single piece of material with a constant cross-section. The support members 38, 48 can also be adjustable to accommodate adjustments in the field at time of installation. Adjustable can refer to slideable concentric sleeves to adjust length of the support members 38, 48, notching and/or scoring to assist length modification of the support members 38, 48, threaded inserts for length adjustments, etc. The clamp 50 can be used to at least partially surround the post 21 and fixedly attach the actuator 42 to the post 21. The post 21 can be a wooden or metal post (or any other suitable material), and can have different cross-sections than the circular cross-section shown in FIG. 3A. For example, the post can be rectangular-shaped, such as with 4×4, 4×6, 6×6, etc. treated lumber, somewhat oval-shaped with wooden or metal posts, etc.

The clamp 50 can at least partially surround the post 21 which can have a diameter 98. The arms of clamp 50 can extend around opposite sides of the post 21 and can be secured together by a fastener 94 and nut 96. By installing the nut 96 onto the fastener 94, the clamp arms are pulled together thereby squeezing the post between the arms and securing the actuator 42 to the post 21.

The retainer 44 can be mounted to the surface 86 with a protrusion extending into engagement with the actuator 42 when the gate is latched in the closed position. The retainer 44 can be engaged and disengaged with the actuator 42 by pivoting (shown by arrows 82) about axis 32 and displacing (shown by arrows 84) the retainer 44 toward and away from the actuator 42. The actuator 42 may have a biasing device that holds the actuator 42 in a closed position. The actuator 42 may have a pivot 46 that allows opening and closing the actuator to retain or release the retainer 44.

The handle 18 can also be proximate the retainer 44 or an integral part of the retainer. As seen in FIG. 3A, the retainer 44 extends from the gate to allow engagement with the actuator 42. The other end of the retainer 44 can form a handle 18. This handle 18 has two knees (or bends) 150, 152 that facilitate elevating the outer surface of the handle 18 away from the surface 86 of the gate. Two other knees are shown that are proximate the surface 86 and allow fasteners 144 to attach the retainer 44 with integral handle 18 to the gate. This configuration can allow a user to operate the latch release and open the gate with only one hand. An additional support 140 can also be attached (welding, brazing, casting, molding, etc.) to the retainer 44 to provide additional strength to the retainer 44 and handle 18. The support can be attached to the metal frame 70 by fasteners 142. The fasteners 142, 144 can be any suitable fastener for attaching these items to the fence material and/or the gate frame material, such as screws, nuts and bolts, rivets, etc. The distance L20 indicates the distance between the closest knee 150 to an end of the actuator 42 with which one-handed operation of the latch 40 and gate handle 18 is provided. The distance L20 can be between and including a ½ inch to 8 inches. This distance L20 can vary within this range and the actual value can be determined during installation and/or prior to installation of the fence system 10. The larger distances (such as 7 and 8 inches) can limit the users that can operate the gate on-handed, but larger handed users would be able to easily operate the gate and latch assembly one-handed.

FIGS. 3B-3E show various retainer 44/handle 18 combinations. These FIGS. correspond to the region in FIG. 3A that is circled by the dashed line.

FIG. 3B is a more detailed view of the region in FIG. 3A with the single body retainer 44 that includes a handle 18 with two knees 150, 152. The retainer 44 can be mounted with fasteners and/or mounted using the additional support 140. The support 140 can be various shapes and sizes as needed to extend from the front surface 86 to the frame member 70, where fasteners 142 can be used to attach the support 140 to the frame member 70. The support can also be welded, glued, clamped, etc. on to the member 70. It is not required for the support 140 to be secured with fasteners 142.

FIG. 3C shows different configuration of a retainer 44 and a handle 18, where the retainer 44 is fastened to the gate 12 by fasteners 144. An additional support 140 can also be included in this configuration extending from the retainer 44 to the member 70. However, it is not required to have the support 140, as is shown in FIG. 3C. The handle 18 is similar to the shape of the handle 18 in FIG. 3B, except that the handle 18 is oriented at 90 degrees from the one in FIG. 3B, the handle is a separate piece from the retainer 44, and a top portion of the handle 18 in FIG. 3C overlays a portion of the retainer 44. It is not a requirement that the handle 18 and the retainer 44 be separate pieces. They could be welded together or otherwise securely attached to each other, but FIG. 3C illustrates that they can be separate pieces. The distance L20 is still measured from the closest knee (or bend) 150 to the end of the actuator 42.

FIG. 3D shows yet another configuration of a retainer 44 and handle 18, with the handle 18 as an integral part of the retainer 44. In this configuration, the support 140 is basically extended from the member 70 to a position for the handle 18, which can be fixedly attached to the end of the support 140 as shown. The handle 18 can be attached at approximately 90 degrees relative to the support 140, but it can also be attached at various angles relative to the support 140 is desired. The retainer 44 is shown attached to the support 140 at a position below the handle 18 and configured to engage with the actuator 42. The handle 18 and/or retainer 44 can be any shape cross section, such as circular, square, rectangular, oval, etc. as desired to facilitate grip by the user and/or engagement with the actuator 42. The handle 18 and/or retainer 44 can also have a varying cross-section, such as varied thickness or diameter, varied shapes, etc. The support 140 can also be attached to the member 70 with fasteners 142 (or fixedly attached) such that a force applied to the handle is transmitted to the member 70, as in the other configurations.

FIG. 3E shows yet another configuration of a retainer 44 and handle 18, with the handle 18 as an integral part of the retainer 44. In this configuration, the support 140 is basically extended from the member 70 with the end of the support 140 formed into the shape of a handle 18. The handle 18 shape in FIG. 3E indicates 45 degrees bends at the knees of the handle, but the handle 18 can be formed as other shapes (such as a semi-circle) that is conducive to being handled by a user. The support 140 of the retainer 44 can be fixedly attached to the member 70 with fasteners 142.

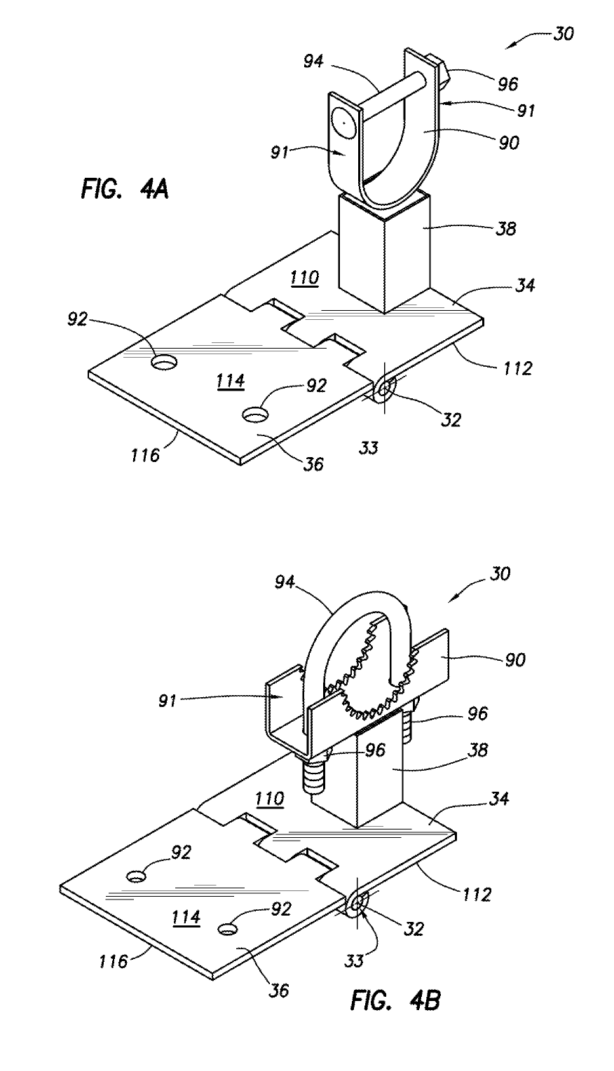

FIGS. 4A, 4B show perspective views of two embodiments of the hinge 30 which can embody principles of the current disclosure. FIG. 4A shows a hinge 30 with left and right members 34, 36, mounting holes 92, pivot 33 (such as a pin, etc.), axis 32, support member 38 and the clamp 90 with arms that are corrected via the fastener 94 and nut 96. The right member 36 can have opposing surfaces 114, 116, with captive nuts 132 attached to the surface 116 at mounting holes 92. The left member 34 cart have opposing surfaces 110, 112, with the support member 38 attached to the surface 110.

FIG. 4B shows a hinge 30 with left and right members 34, 36, mounting holes 92, pivot 33, axis 32, support member 38 and a clamp 90 made from a channel material with teeth formed in a semicircle arrangement that can mate up to a post 20 with a circular cross-section. The fastener 94 is shown as a U-bolt that can surround the post 20 and be secured to the clamp 90 via nuts 96, thereby securing the hinge 30 to the post 20. The right member 36 can have opposing surfaces 114, 116, with captive nuts 132 attached to the surface 116 at mounting holes 92. The left member 34 can have opposing surfaces 110, 112, with the support member 38 attached to the surface 110.

FIGS. 5A-5C are detailed views of the hinge 30 shown in FIG. 4A. FIG. 5A is a cross-sectional top view of the hinge 30 of FIG. 4A. The captive nuts 132 can be fixed to the surface 116 at the mounting hole 92. Length L24 is the length from the surface 110 to an extern of the clamp 90. Length L23 is a width of the clamp 90, where length L23 can determine the length needed for the arms to extend around the diameter 98 of the post 20. The length L6 is the length of the support 38 as measured from the surface 110 to an interface between the clamp 90 and the support member 38. Length L4 is the distance from tire surface 110 to the center 72 of the post 20. Length L10 is the distance from the center 72 of the post 20 to the axis 32 of the hinge 30. This length L10 is also the combined lengths of length L1 and length L7, where length L1 is the distance from the axis 32 to the surface 28 of the left portion 56 of the fence system 10, and length L7 is the distance from the axis 32 to the surface 28.

FIG. 5B shows a representative cross-section of the support member 38 of the hinge 30, This view shows a substantially constant cross-section 120 of the support member 38. It is preferred that the cross-section of the support member 38 be substantially constant (or in other words substantially the same) for the length L6 of the support member 38. As used herein, “substantially constant: cross-section” refers to a cross-section that is maintained along the specified length (e.g. L6) with about the same thickness of wails and about the same shape. There may be some anomalies in the cross-section along this length, but generally the cross-section is constant.

FIG. 5C details the relative lengths of the features and positions of features of the hinge 30 of FIG. 4A. L11 is the overall height of the hinge 30. L12 is the distance between centers of the mounting holes 92. L13 is the distance from the bottom of the hinge 30 to the center of the bottom one of the mounting holes 92. The home right member 36 has a surface 116 to which the nuts 132 can be attached. L14 is the distance from the edge of the right member 36 to the center of the mounting hole 92. It is preferred that the holes 92 are aligned with each other as shown in the figures, but this alignment is not required. L15 is the length of the overall width of the hinge 30 when it is in its fully open position. L16 is a width of the right member 36 excluding the hinge pivot surface 108. L18 is the width of the left member 34 excluding the hinge pivot surface 108. L17 is the width of a hinge pivot surface 108 of the hinge pivot. L19 is the distance from the center of the mounting hole 92 to the surface 108. L21 is the distance from the axis 32 to the hinge pivot surface 108. Cross-section 120 is shown as dashed lines for the support member 38. L22 is the width of the arms of the clamp 90.

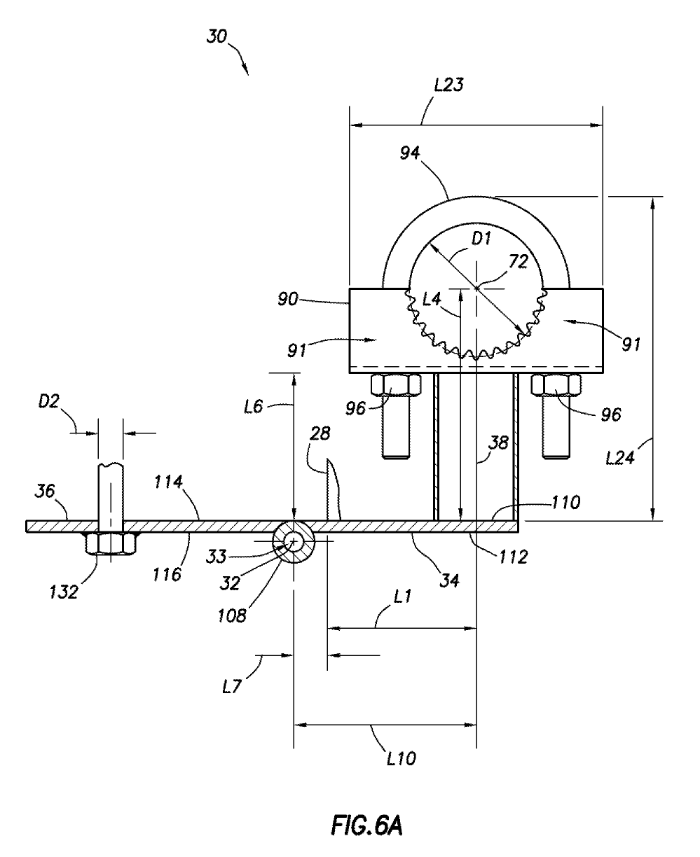

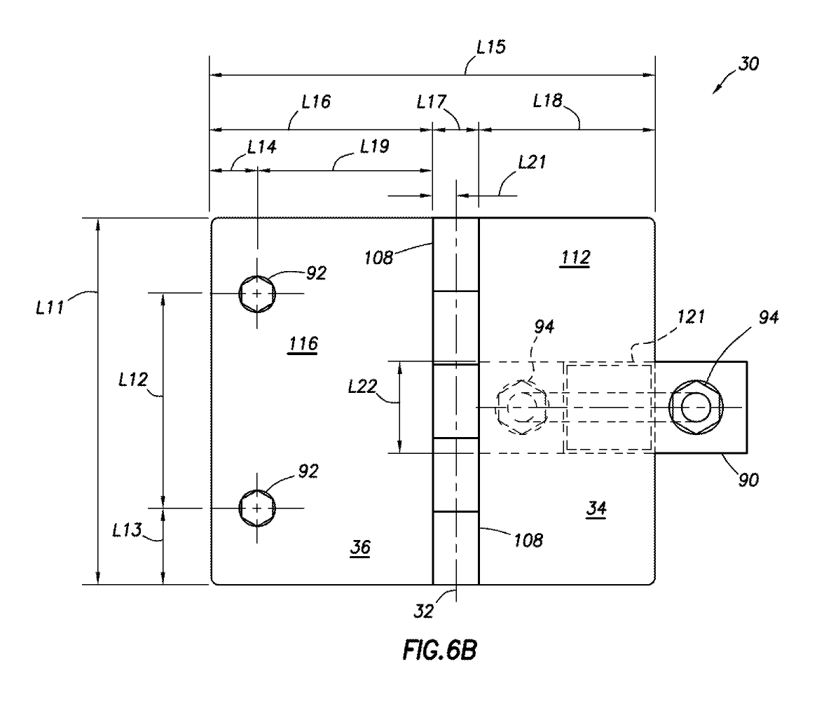

FIGS. 6A, 68 are detailed views of the hinge 30 shown in FIG. 4B. FIG. 6A is a cross-sectional top view of the hinge 30 of FIG. 4B. FIGS. 6A, 6B are very similar to FIGS. 5A and 5C, except that the clamp 90 is of a different configuration for mounting the hinge 30 to the post 20. The description above for FIGS. 5A, 5C is applicable to the lengths shown in FIGS. 6A, 6B with the same reference numerals.

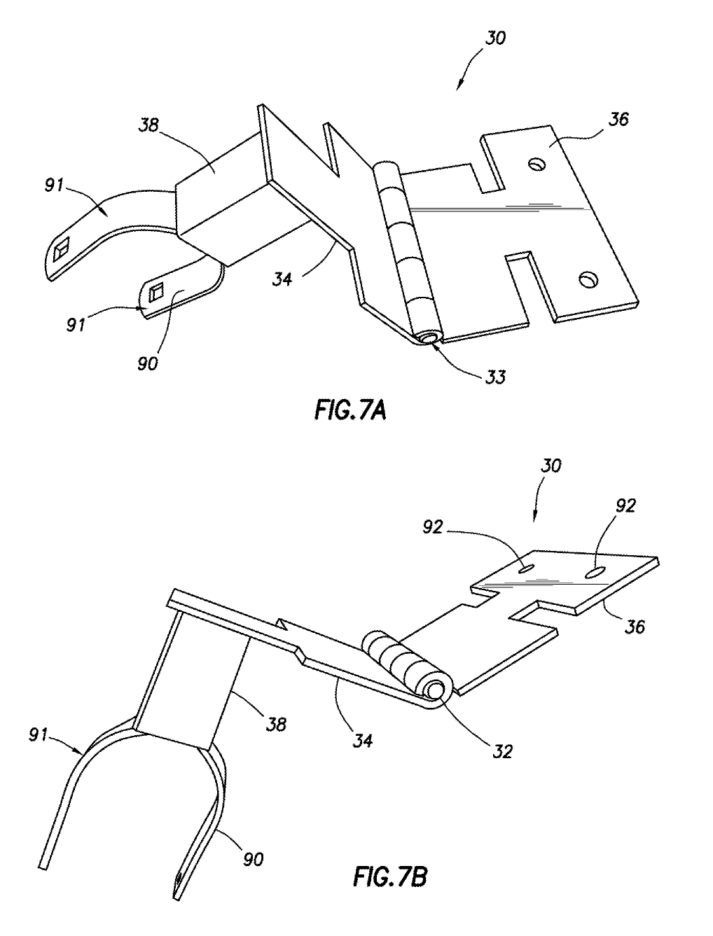

FIGS. 7A and 7B show perspective views of the hinge 30 with slightly different construction of the left and right members 34, 36, as compared to FIGS. 4A-6B.

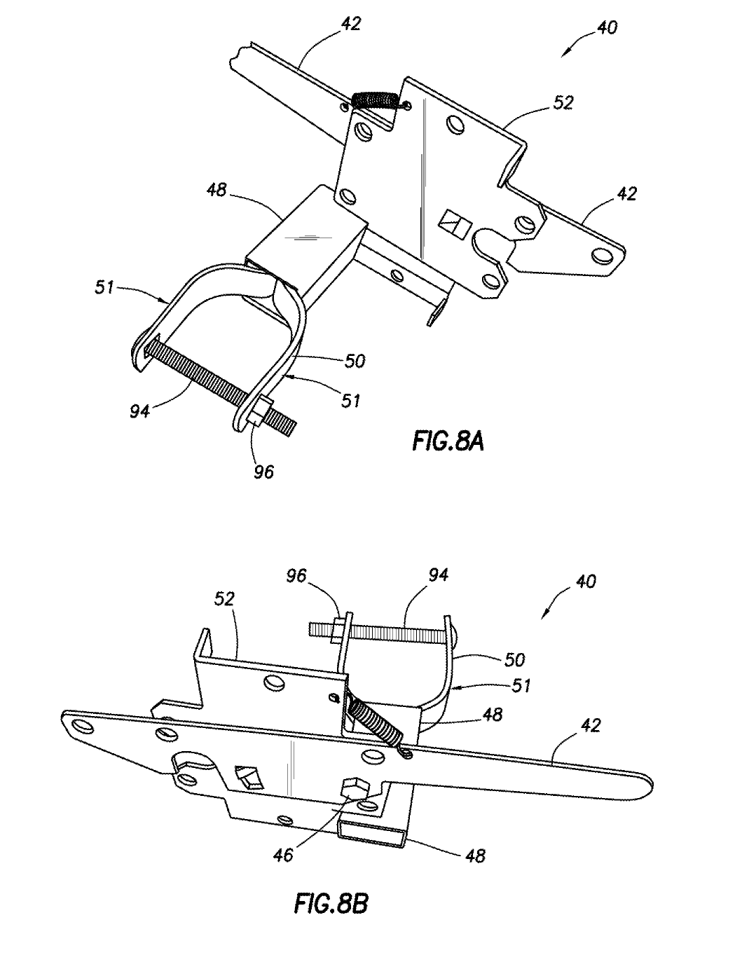

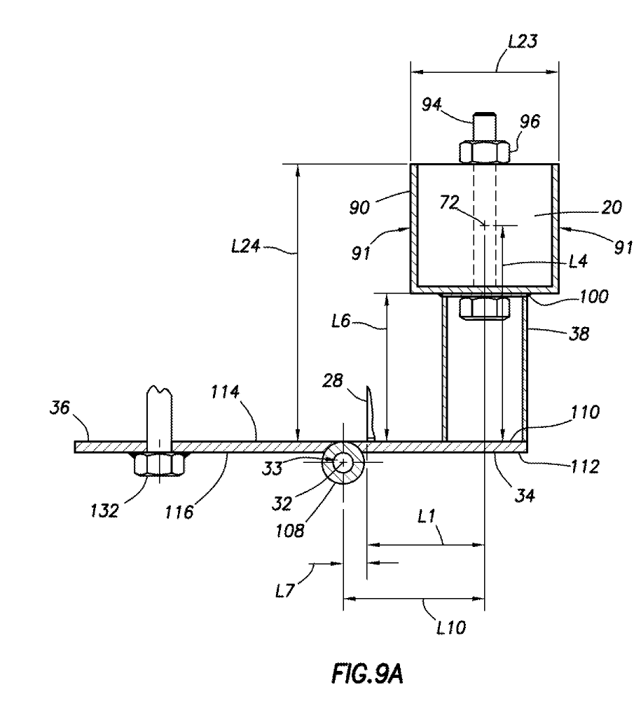

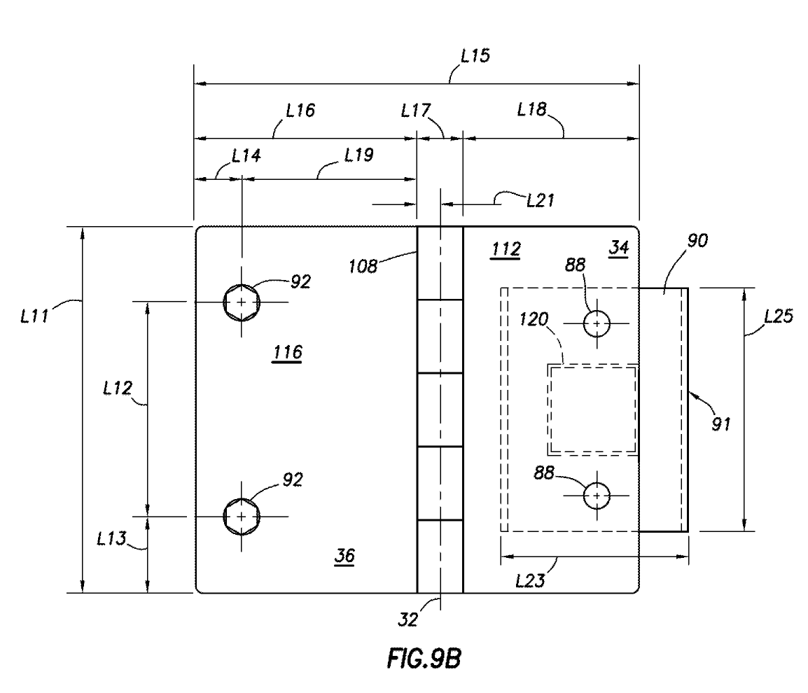

FIGS. 8A and 8B show perspective views of the latch 40, with actuator 42, and the retainer 44 not displayed. The actuator 42 can rotate about pivot 46 to retain and release the retainer 44. The damp 50 is similar to the damp 90 shown in FIG. 5A, but it is understood that the clamp 50 can also be similar to the different configurations shown for the damp 90 in FIGS. 6A and 9A, as well as other configurations that have not been shown in the figures.

FIGS. 9A, 9B are very similar to FIGS. 5A and 5G, except that the clamp 90 is of a different, configuration tor mounting the hinge 30 to the post 20. The description above tor FIGS. 5A, 5C is applicable to the lengths shown in FIGS. 9A, 9B with the same reference numerals, even though the lengths between these two versions can be different, the descriptions of the relative lengths arc the same for the same reference numerals.

Thus, a fence system 10 is provided that can include first and second fence portions 56, 58, a gate assembly 12 positioned between the first and second fence portions 56, 58, at least one hinge 30 that rotatably mounts the gate assembly 12 to a first post 20 of the first fence portion 56, and the hinge 30 comprises a first clamp 90, 50 that straddles the first post 20 and secures the hinge 30 to the first post 20.

Other embodiments of the system 10 may generally include first and second fence portions 56, 58, a gap between the first and second fence portions 56, 58 with an edge of each fence portion 56, 58 adjacent the gap and forming a plane, and a gate assembly 12 positioned in the gap, with at least first and second hinges 30 rotatably mounting the gate assembly 12 to a first post 20 of the first fence portion 56, and wherein each of the hinges 30 comprise a first clamp 90, 50 with opposing arms 91 that extend at least partially around opposite sides of the first post 20 and secure the respective first and second hinges 30 to the first post 20.

For any of the foregoing embodiments, the system 10 may include any one of the following elements, alone or in combination with each other:

The hinge 30 can also include first and second members 34, 36 rotatably attached to a pivot 33 with an axis 32 around which the members 34, 36 rotate, and a first support member 38 which is attached between the first member 34 and the first clamp 90, 50, where the first support member 38 secures the first clamp 90, 50 at a location that is spaced apart from the first member 34, and where the first support member 38 has a substantially constant cross-section. The first support member 38 can be perpendicular to the first member 34. The first clamp 90, 50 can be secured to the first post 20 by at least one fastener 94, and the second member 36 can be attached to the gate assembly 12, thereby rotatably mounting the gate assembly 12 to the first post 20. The fastener 94 (such as a bolt, a U-shaped bolt, and a screw, etc.) can connect between opposite arms 91 of the first clamp 90, 50 to secure the first clamp 90, 50 to the first post 20. A latch retainer 44 can be attached to one of the gate assembly 12 and the second fence portion, and a latch actuator 42 can be attached to dm other one of the gate assembly 12 and the second fence portion, where engagement of the retainer 44 with the actuator 42 latches the gate assembly 12 in a closed position. Rotation of the latch actuator 42 can selectively release the latch retainer 44, thereby permitting rotation of the gate assembly 12 from the dosed position, where the attachment to the gate assembly 12 includes attachment to a metal support of the gate assembly 12.

The latch retainer 44 and the latch actuator 42 can be attached to a second post of the second fence portion via a second damp that straddles the second post and secures the second post to the one of the latch retainer 44 and the latch actuator 42. The second clamp can be secured to the second post by at least one fastener, such as a bolt, a U-shaped bolt, and a screw.

The first and second members 34, 36 rotatably attached to a pivot 33 with an axis 32 around which the members rotate, and a first support member 38 which is attached between the first member 34 and the first clamp 90, 50, where the first support member 38 secures the first clamp 90, 50 at a location that is spaced apart from the first member 154, and where the first support member 38 has a substantially constant cross-section. The first and second hinges 30 can rotatably attach the gate assembly 12 to the first post 20 without attachment of either one of the first and second hinges 30 to and/or through pickets 14 and/or backer rails 22, 24 of the first fence portion 56.

Other embodiments of the system 10 may generally include first and second fence portions 56, 58, a gate assembly 12 positioned between the first and second fence portions 56, 58, at least one hinge 30 that rotatably mounts the gate assembly 12 to a first post 20 of the first fence portion 56, and a latch system that can include a latch actuator 42, a latch retainer 44, and a handle 18, where the latch retainer 44 engages the latch actuator 42 and latches the gate assembly 12 in a closed position, and where the handle 18 allows a user to grip dm handle 18 and manipulate the actuator 42 with one hand, which disengages the latch retainer 44 from the latch actuator 42.

The handle 18 can include a knee (or bend) 130 with the handle 18 being positioned such that the knee 150 is at a distance of 8 inches or less from the latch actuator 42. The knee 150 can also be positioned at a distance of 6 inches or less, 4 inches or less, and 2 inches or less from the latch actuator 42. The latch retainer 44 can be attached to the gate assembly 12 and a latch actuator 42 can be attached to the second fence portion 58, where the manipulation of the actuator 42 causes rotation of the latch actuator 42 which selectively releases the latch retainer 44 and permits rotation of the gate assembly 12 from the closed position.

Other embodiments of the system 10 may generally include first and second fence portions 56, 58, a gap between the first and second fence portions 56, 58, with an edge of each fence portion 56, 58 adjacent the gap and forming a plane, and a gate assembly 12 positioned in the gap, where at least first and second hinges 30 rotatably mount the gate assembly to a low post 20 of the first fence portion 56, and a latch system 40 that can include a latch actuator 42 attached to the second portion 58, a latch retainer 44 attached to the gate assembly 12, and a handle 18 attached proximate the latch retainer 44 on the gate assembly 12, where the latch retainer 44 engages the latch actuator 42 and latches the gate assembly 12 in a closed position, and where the handle 18 is configured to allow a user to grip the handle 18 and manipulate the actuator 42 with one hand, which can disengage the latch retainer 44 from the latch actuator 42.

The hinges 30 can include a first clamp 50, 90 with opposing arms 91 that extend at least partially around opposite sides of the first post 20 and secure the respective first and second hinges 30 to the first post 20, 11. The first and second hinges 30 can also include first and second members 34, 36 rotatably attached to a pivot 33 with an axis 32 around which the members rotate, and a first support member 38 which is attached between the first member 34 and the first clamp 90.

A method for installing a gate assembly 12 between first and second portions 56, 58 of a fence system 10 is also provided, which can include operations of mounting a first member 34 of a hinge 30 to a first post 20 of the first portion 56, where the first post 20 is inset from a front surface 28 of the first portion 56, and the mounting further comprises clamping a clamp 90, 50 of the hinge 30 around the first post 20, and mounting a second member 36 of the hinge 30 to a side of a gate assembly 12, thereby rotatably attaching the gate assembly 12 to the first portion 56.

A method of opening a gate assembly that is positioned between first and second portions 56, 58 of a fence system 10 is also provided, which can include operations of mounting a hinge 30 between a gate assembly 12 and the first portion 56, thereby rotatably mounting the gate assembly 12 to the first portion 56, mounting a latch retainer 44 to an opposite side of the gate assembly 12 from the hinge 30, mounting a latch actuator 42 to the second portion 58, retaining the latch retainer 44 with the latch actuator 42, thereby holding the gate assembly 12 In a closed position, and positioning a handle 18 on the gate assembly 12 proximate the latch actuator 42, thereby allowing a user to grip the handle 18 and manipulate the actuator 42 using only one hand.

For any of the foregoing embodiments, the methods may include any one of the following operations, alone or in combination with each other:

The operations can also include mounting one of a latch retainer 44 and a latch actuator 42 to an opposite side of the gate assembly 12 from the second member 34, and mounting the other one of the latch retainer 44 and the latch actuator 42 to a second post of the second portion 58, where the second post 21 is inset from a front surface 28 of the second portion 58. Rotating the gate assembly 12 to a closed position, engaging the latch actuator 42 with the latch retainer 44, and retaining the latch retainer 44 with the latch actuator 42, thereby holding the gate assembly 12 in a closed position. The mounting of the first member 34 can also include mounting the first member 34 to the first post 20 without mounting the first member 34 to pickets 14 or backer rails 22 of the first portion 56.

The operations can also include releasing the latch retainer 44 due to the manipulation, rotating the gate assembly 12 away from the closed position due to the releasing of the latch retainer 44. The handle 18 can include a first knee 150 and the handle 18 can be positioned such that the knee is at a distance of 8 inches or less, 6 inches or less, 4 inches or less, and 2 inches or less from the latch actuator 42.

Although various embodiments have been shown and described, the disclosure is not limited to such embodiments and will be understood to include all modifications and variations as would be apparent to one skilled in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

1. A fence system, where the system comprises:
first and second fence portions;
a gate assembly positioned between the first and second fence portions;
at least one hinge that rotatably mounts the gate assembly to a first post of the first fence portion; and
a latch system that comprises:
a latch actuator,
a latch retainer,
and a handle,
wherein the latch retainer engages the latch actuator and latches the gate in a closed position, and
wherein the handle is configured to allow a user to grip the handle and manipulate the actuator with one hand, which disengages the latch retainer from the latch actuator.

2. The fence system of claim 1, wherein the handle has a knee and the handle is positioned such that the knee is at a distance of 8 inches or less from the latch actuator.

3. The fence system of claim 2, wherein the knee is at a distance of 6 inches or less from the latch actuator.

4. The fence system of claim 2, wherein the knee is at a distance of 4 inches or less from the latch actuator.

5. The fence system of claim 2, wherein the knee is at a distance of 2 inches or less from the latch actuator.

6. The fence system of claim 1, wherein the latch retainer is attached to the gate assembly and a latch actuator is attached to the second fence portion, and wherein the manipulation of the actuator causes rotation of the latch actuator which selectively releases the latch retainer and permits rotation of the gate assembly from the closed position.

7. The fence system of claim 1, wherein the hinge comprises a first clamp that straddles the first post and secures the hinge to the first post.

8. The fence system of claim 7, wherein the latch actuator is attached to a second post of the second fence portion via a second clamp that straddles the second post and secures the latch actuator to the second post.

9. A fence system, where the system comprises:
first and second fence portions;
a gap between the first and second fence portions, with an edge of each fence portion adjacent the gap and forming a plane; and
a gate assembly positioned in the gap, wherein at least first and second hinges rotatably mount the gate assembly to a first post of the first fence portion, and
a latch system that comprises:
a latch actuator attached to the second portion,
a latch retainer attached to the gate assembly,
and a handle attached proximate the latch retainer on the gate assembly,
wherein the latch retainer engages the latch actuator and latches the gate in a closed position, and
wherein the handle is configured to allow a user to grip the handle and manipulate the actuator with one hand, which disengages the latch retainer from the latch actuator.

10. The fence system of claim 9, wherein each of the hinges comprise a first clamp with opposing arms that extend at least partially around opposite sides of the first post and secure the respective first and second hinges to the first post.

11. The fence system of claim 10, wherein each of the first and second hinges further comprise:
first and second members rotatably attached to a pivot with an axis around which the members rotate; and
a first support member which is attached between the first member and the first clamp, wherein the first support member secures the first clamp at a location that is spaced apart from the first member, and wherein the first support member has a substantially constant cross-section.

12. A method of opening a gate assembly between first and second portions of a fence system, the method comprising:
mounting a hinge between a gate assembly and the first portion, thereby rotatably mounting the gate assembly to the first portion;
mounting a latch retainer to an opposite side of the gate assembly from the hinge; mounting a latch actuator to the second portion;
retaining the latch retainer with the latch actuator, thereby holding the gate assembly in a closed position; and
positioning a handle on the gate assembly proximate the latch actuator, thereby allowing a user to grip the handle and manipulate the actuator using only one hand.

13. The method of claim 12, further comprising releasing the latch retainer due to the manipulation.

14. The method of claim 13, further comprising rotating the gate assembly away from the closed position due to the releasing of the latch retainer.

15. The method of claim 12, wherein the handle comprises a first knee and the handle is positioned such that the knee is at a distance of 8 inches or less from the latch actuator.

16. The method of claim 15, wherein the knee is at a distance of 6 inches or less from the latch actuator.

17. The method of claim 15, wherein the knee is at a distance of 4 inches or less from the latch actuator.

18. The method of claim 15, wherein the knee is at a distance of 2 inches or less from the latch actuator.

19. The method of claim 12, further comprising.
mounting a first member of the hinge to a first post of the first portion by clamping the hinge around the first post;
mounting a second member of the hinge to the opposite side of the gate assembly, thereby rotatably attaching the gate assembly to the first post; and
mounting a latch actuator to a second post of the second portion.

20. The method of claim 19, further comprising:
rotating the gate assembly to a closed position;
engaging the latch actuator with the latch retainer; and
retaining the latch retainer with the latch actuator, thereby holding the gate assembly in a closed position.
